(19) United States
(12) Patent Application Publication
(10) Pub. No.: US 2009/0221416 A1
(43) Pub. Date: Sep. 3, 2009

(54) Molding Compound for Producing a Refractory Lining

(76) Inventors: Holger Grote, Bonn (DE); Wolfgang Kollenberg, Brühl (DE); Dieter Nikolay, Bell (DE); Marc Tertilt, Hattingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/922,820

(22) PCT Filed: Jun. 30, 2006
(86) PCT No.: PCT/EP2006/063717

§ 371 Date: Apr. 15, 2009

(30) Foreign Application Priority Data
Jul. 1, 2005 (EP) 05014376.7

(51) Int. Cl. C04B 35/10; C04B 35/64; C04B 35/18

(52) U.S. Cl. 501/128; 264/681

(57) ABSTRACT

In one aspect, a molding compound for producing a refractory lining, especially for a combustion chamber of a stationary gas turbine is provided. The molding compound comprises, in weight percent, more than approximately 50% of aluminum oxide and, in weight percent, less than approximately 50% of aluminum silicate.

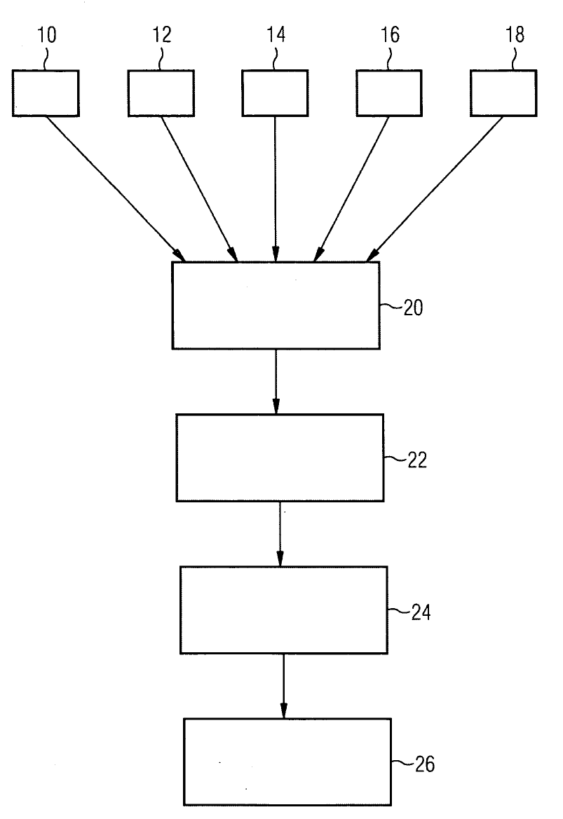

### CROSS REFERENCE TO RELATED APPLICATIONS

This application is the U.S. National Stage of International Application No. PCT/EP2006/063717, filed Jun. 30, 2006 and claims the benefit thereof. The International Application claims the benefits of European Patent Office application No. 05014376.6 EP filed Jul. 1, 2005, both of the applications are incorporated by reference herein in their entirety.

### FIELD OF INVENTION

The invention relates to a molding compound for producing a refractory lining, especially for a combustion chamber of a stationary gas turbine. The invention further relates to a fired molded part, which has been produced on the basis of this type of molding compound, to an associated refractory lining, as well as finally also to a method for producing a fired molded part of a refractory lining.

### BACKGROUND OF INVENTION

In the field of combustion chamber technology, such as with gas turbine combustion chambers for example, the walls of high-temperature reactors must be protected by suitable linings or shielding, so that in particular supporting structures lying behind them are protected against being attacked by heat. As a rule ceramic materials are generally more suitable for shielding than metallic materials, since they are more resistant to temperature as well as to corrosion and exhibit a lower thermal conductivity.

The ceramic linings, often also referred to as ceramic heat shields, have as a rule been produced using a sintering process, in which the protective characteristics of the ceramics have also been defined.

High demands are also imposed on the ceramic heat shields as regards their ability to withstand mechanical loads and increasing attempts are being made in this area to improve the shields by producing composite components, such as fiber-reinforced components based on CMC (ceramic matrix composites), or by trying to obtain especially good mechanical characteristics with structure ceramic components or graded components.

### SUMMARY OF INVENTION

One object of the invention is to provide a molding compound as well as a fired molded component produced from said compound for a refractory lining of the above-mentioned type, which can be processed at a comparatively low sinter temperature for example, and thereby to open up new opportunities for the development of high-temperature-resistant composite components.

The molding compound must meet the requirements imposed on ceramic components for use in stationary gas turbines in the hot gas path.

The inventive object is achieved with a molding compound for producing a refractory lining which is formed with a percentage by weight of more than approximately 50% aluminum oxide and a percentage by weight of less than 50% aluminum silicate. The object is further achieved by a fired molded part for a refractory lining which comprises a percentage by weight of more than approximately 50% and less than approximately 90% aluminum oxide and/or a percentage by weight of more than approximately 10% and less than approximately 50% aluminum silicate. In addition the inventive object is also achieved by a method for producing a fired molded part of a refractory lining which comprises the following steps: Producing a molding compound with at least the components aluminum oxide and aluminum silicate by adding colloidal silicic acid solution, molding the compound while vibrating it, sudden reduction of the temperature of the molding compound as well as drying and firing of the molded compound. The molding compound can further contain a percentage by weight of less than approximately 30%.

The molding compound inventively formed from said specific percentage by weight of aluminum oxide or aluminum silicate forms a basic material which especially advantageously hardens by addition of colloidal silicic acid in a so-called sol-gel process and can be further worked by pouring and vibration. The silicic acid initially present in this case as a sol or colloidal solution is changed into a gel by a sudden reduction in the temperature and thereby the molding compound, which can also be referred to as the pouring mass or vibration mass, is hardened. The actual drying and sintering process can subsequently be undertaken at comparatively low firing temperatures, as will be explained in greater detail below.

Especially advantageously aluminum oxide corundum, i.e. aluminum oxide in a trigonal structure with the chemical formula Al₂0₃, especially with a percentage by weight of between approximately 50% and 90%, is used for the inventive molding compound.

The percentage by weight of the aluminum silicate used especially advantageously amounts to between approximately between 10% and 50%, most preferably to less than approximately 45%. The aluminum silicate is in this case advantageously mullite with the chemical formula 3Al₂O₃-2SiO₂ or 2Al₂O₃-1SiO₂.

Furthermore the inventive molding compound should advantageously be free of unbonded silicon oxide, SiO₂ or the percentage by weight of such silicon oxide should be at least less than approximately 5%. Finally it is also of advantage for the molding compound to be free of calcium aluminates.

The percentage by weight of the inventively added colloidal silicic acid solution should advantageously amount to less than approximately 10%. Furthermore the colloidal silicic acid solution should have a solids content of at least around 30 percent by weight.

To make the compound easy to work a liquid, especially water, with a percentage by weight of more than approximately 1% and less than approximately 10%, should be added to the compound.

The maximum grain size should typically lie between approximately 20 and approximately 5 mm. The percentage by weight of this grain fraction should be less than approximately 25%.

As an alternative or in addition the inventive molding compound should be supplemented with a percentage by weight of less than approximately 30%, especially of less than approximately 25% reactive alumina.

The inventive fired molded part should have in its composition percentages by weight which essentially correspond to those of the above-mentioned molding compounds. The open porosity of the fired molding compound should amount to more than approximately 10%, especially more than approximately 15% and less than approximately 35%. The inventive advantageously desirable raw density of the fired molding compound amounts to less than approximately 3.5 g/cm³, especially less than approximately 3.0 g/cm³ .

As regards the desired mechanical characteristics, the inventive fired molded part should be set to an average tensile strength under normal conditions of more than approximately 7.0 MPa. The specified average tensile strength is measured in such cases with a 3-point bending test.

The molded part produced in this way from an inventive molding compound can especially advantageously be used as a refractory lining for combustion chambers of stationary gas turbines. The production process, as already mentioned above, involves producing the molding using vibration by hardening on the basis of colloidal silicic acid solution. To achieve this hardening the ambient temperature of the molding compound is preferably reduced according to the invention to a temperature of less than approximately 0° C. and is held there especially over a period of more than approximately 15 minutes and less than approximately 2.5 hours. Especially preferred is a cooling temperature in the region of approximately −20° C. to approximately −40° C.

The finished molded compound is inventively preferably fired at a temperature of between approximately 1300° C. and approximately 1650° C. For the firing of a monolith ceramic a temperature of between approximately 1350° C. and approximately 1650° C. is preferred within this temperature range. A fiber-reinforced ceramic is preferably fired at a temperature of between approximately 1300° C. and approximately 1400° C. For structure ceramics a firing temperature of between approximately 1300° C. and approximately 1600° C. is preferred according to the invention.

### BRIEF DESCRIPTION OF THE DRAWINGS

An exemplary embodiment of an inventive molding compound, of a molded part produced from it, and a refractory lining formed with it as well as an associated method for producing the lining is explained in greater detail with reference to the enclosed schematic drawings.

The FIGURE shows a schematic flowchart of a production method of a refractory lining including the preparation of the molding compound used.

### DETAILED DESCRIPTION OF INVENTION

In accordance with the FIGURE, a molded part provided as a refractory lining of a combustion chamber of a stationary gas turbine is produced from a molding compound, which is mixed together in a first operating step from essentially five components.

These five components are indicated in the figure with the reference symbols 10, 12, 14, 16 and 18 and in this sequence contain corundum (Al₂0₃), mullite (2Al₂0₃-1SiO₂), silicic acid (Si(OH)₄), water (H₂O) as well as reactive alumina. The percentages by weight of these materials for corundum as aluminum oxide, amount to between approximately 55% and 70%, for mullite as aluminum silicate to between approximately 30% and 45% and for water to between approximately 4% and 7%. Silicic acid is added as a sol or colloidal solution with percentage by weight of between approximately 4% and 8%. The percentage of reactive alumina amounts to between approximately 15% and 30%.

The said components are added together in a mixing procedure labeled 20 in the figure to form a molding compound which is subsequently molded in a mold while being vibrated in a molding process labeled 22.

The mold prepared in this way is cooled suddenly starting from room temperature, by being subjected to an atmosphere with a temperature of approximately −25° C. This sudden cooling down of the molding compound in the mold causes the silicic acid located therein as sol to become a gel. In this case the molding compound as a whole is hardened and in an especially advantageous manner is prepared for a last working step of drying and firing indicated by reference symbol 26.

With this working step 26 the molding compound is fired at a sinter temperature of between approximately 1300° C. and approximately 1600° C. Because of this comparatively low firing temperature there can be fiber reinforcements in the molding compound used so that overall a fiber-reinforced ceramic can be produced.

The ceramic produced especially advantageously features mechanical characteristics with an especially low tendency to form thermal cracks. This is based especially on the fact that a specific framework of microfractures has been created in the ceramic by the said sol-gel process and also as a result of the high percentage of aluminum oxide, one of the results of which is for example a sharp reduction in the crack lengths of edge cracks.

In this way the risk of loss of ceramic heat shields on the lining can be reduced with the inventive method and the number of maintenance and replacement cycles of the heat shields can be reduced. Overall a longer lifetime can be achieved.

In addition, another particular advantage of the invention which can also be mentioned as that the molded compound is free of cement overall (meaning that essentially it features no CaO) and that cost benefits in the production process also emerge as a result of the lower sinter temperature.

1-13. (canceled)

14. A method for producing a fired molded part of a refractory lining for a combustion chamber of a stationary gas turbine, the method comprising:
producing a first compound comprising aluminum oxide, and aluminum silicate;
adding to the first compound a silicic acid solution to form a second compound;
forming the part from the second compound via a vibration process;
reducing of the temperature of the second compound suddenly; and
firing the part.

15. The method as claimed in claim 14, wherein the first compound comprises by weight more than 50% aluminum oxide.

16. The method as claimed in claim 15, wherein less than 10% colloidal silicic acid solution, by weight, is added to the first compound.

17. The method as claimed in claim 16, wherein in which the colloidal silicic acid solution comprises, by weight, more than 30% of solids.

18. The method as claimed in claim 14, wherein the second compound comprises water with a percentage by weight of more than 1% and less than 10%.

19. The method as claimed in claim 14, wherein the second compound comprises reactive alumina with a percentage by weight of less than 30%.

20. The method as claimed in claim 19, wherein the second compound comprises reactive alumina with a percentage by weight of less than 25%.

21. The method as claimed in claim 14, wherein temperature is reduced during the sudden reduction to less than 0° C. and is held there especially over a period of more than 15 minutes and less than 2.5 hours.

22. The method as claimed in claim 14, wherein the part is fired at a temperature of between 1300° C. and 1650° C.

23. A fired molded part for a refractor lining formed from a compound comprising aluminum oxide, aluminum silicate, and silicic acid solution which is molded with a vibration process and rapidly cooled to harden the part which is then fired at a low temperature.

24. The fired molded part as claimed in claim 22, having an open porosity of more than 10% and less than 35 %.

25. The fired molded part as claimed in claim 22, having with a raw density of less than 3.5 g/cm³.

26. The fired molded part as claimed in claim 22, having of which the average tensile strength under normal conditions is set to more than 7.0 MPa

27. A refractory lining of a combustion chamber of a stationary gas turbine comprising aluminum oxide, aluminum silicate, and silicic acid solution which is molded with a vibration process and rapidly cooled to harden the part which is then fired at a low temperature.

28. The fired molded part as claimed in claim 27, having an open porosity of more than 10% and less than 35%.

29. The fired molded part as claimed in claim 27, having with a raw density of less than 3.5 g/cm³.

30. The fired molded part as claimed in claim 27, having of which the average tensile strength under normal conditions is set to more than 7.0 MPa
